(19) United States
(12) Patent Application Publication
(10) Pub. No.: US 2025/0284565 A1
(43) Pub. Date: Sep. 11, 2025

(54) Common Communication Channel for Inter-Node, Inter-Application, and Intra-Application Communication Within a Storage System

(71) Applicant: Dell Products, L.P., Hopkinton, MA (US)

(72) Inventor: Anjli Chikara, Bangalore (IN)

(21) Appl. No.: 18/595,644

(22) Filed: Mar. 5, 2024

(51) Int. Cl. G06F 9/54

(52) U.S. Cl. CPC G06F 9/542

(57) ABSTRACT

A common communication channel, implemented as a distributed event store, is provided to implement all inter-node, inter-application, and intra-application communication within a storage system. The distributed event store may be implemented as a Kafka server/cluster that hosts topics that applications subscribe to as producers, consumers, or both. An Intelligent Log Driver controls creation of the topics on the Kafka server and also is a subscriber and producer on select topics. The Intelligent Log Driver also interacts with the storage system API to implement configuration changes of the storage system based on commands received on the topics and based on application activity observed on the topics. By providing a common communication channel for all inter-node, inter-application, and intra-application communication within a storage system, it is possible to simplify communication between applications, such as between a storage system management application, software defined network attached storage applications, and the underlying storage system.

### FIELD

This disclosure relates to computing systems and related devices and methods, and, more particularly, to a common communication channel for inter-node, inter-application, and intra-application communication within a storage system.

### SUMMARY

The following Summary and the Abstract set forth at the end of this document are provided herein to introduce some concepts discussed in the Detailed Description below. The Summary and Abstract sections are not comprehensive and are not intended to delineate the scope of protectable subject matter, which is set forth by the claims presented below.

All examples and features mentioned below can be combined in any technically possible way.

In some embodiments, a common communication channel for inter-node, inter-application, and intra-application communication within a storage system is provided. In some embodiments, a distributed event store is provided to implement the common communication channel. In some embodiments, the distributed event store is implemented as a Kafka server or cluster of Kafka servers that hosts topics that applications subscribe to as producers, consumers, or both. An Intelligent Log Driver controls creation of the topics on the Kafka server and also is a subscriber and producer on select topics. The Intelligent Log Driver also interacts with the storage system API to implement configuration changes of the storage system based on commands received on the topics and based on application activity observed on the topics. By providing a common communication channel for inter-node, inter-application, and intra-application communication within a storage system, it is possible to simplify communication between applications, such as between a storage system management application and the underlying storage system, and between software defined network attached applications and other forms of applications resident on virtual machines on the storage system.

In some embodiments, a method of using a common communication channel for inter-node, inter-application, and intra-application communication within a storage system, includes creating, by an intelligent log driver, a set of communication topics on a distributed event store, subscribing, by the intelligent log driver to the set of communication topics as a consumer, producer, or both, and selectively subscribing, by each application, to a respective first subset of the communication topics as a producer on the respective first subset of communication topics, and selectively subscribing, by each application, to a respective second subset of the communication topics as a consumer on the respective second subset of communication topics. The method includes publishing messages containing events, logs, or commands, on individual communication topics of the respective first subsets of communication topics by the applications, receiving the messages containing the events, logs, or commands, from the individual communication topics of the respective first subsets of communication topics by the intelligent log driver, and implementing commands on the storage system, by the intelligent log driver, in response to messages received from the applications on first subsets of communication topics.

In some embodiments, the distributed event store is a Kafka server.

In some embodiments, the first subset of communication topics and the second subset of communication topics at least partially overlap. In some embodiments, at least some of the applications are instantiated in different virtual machines on the storage system, and the method further includes using the communication topics to enable communication between the instances of the applications instantiated in the different virtual machines.

In some embodiments, the set of communication topics created by the intelligent log driver on the distributed event store includes an events topic. In some embodiments, selectively subscribing, by each application, to the respective first subset of the communication topics as producers includes subscribing to the events topic as producers and publishing messages on the events topic related to occurrence of events at the respective applications. In some embodiments, selectively subscribing, by each application, to the respective second subset of the communication topics as consumers includes subscribing to the events topic as consumers, reading the messages published to the events topic, and using the content of the messages published to the events topic to update respective user interface displays in accordance with the content of the messages read from the events topic.

In some embodiments, subscribing, by the intelligent log driver to the set of communication topics as a consumer includes subscribing to the events topic both as a consumer and as a producer. The method further includes determining from the messages published to the events topic that one of two instances of a given application needs to be elected as master application, and in response to determining that one of the two instances of the given application needs to be elected as the master application, publishing an election decision on the events topic to notify the two instances of the application which of the two instances has been elected the master application.

In some embodiments, the set of communication topics created by the intelligent log driver on the distributed event store includes a logs topic. In some embodiments, selectively subscribing, by each application, to the respective first subset of the communication topics as producer includes subscribing to the logs topic as producers and publishing messages containing logs related to application execution errors to the logs topic. In some embodiments, subscribing, by the intelligent log driver to the set of communication topics as a consumer includes subscribing to the logs topic as a consumer. In some embodiments, the method further includes reading the published messages containing the logs related to application execution errors by the intelligent log driver, and in response to reading the published messages, interacting by the intelligent log driver with a storage system operating system to adjust physical resources made available to the applications by the storage system.

In some embodiments, the set of communication topics created by the intelligent log driver on the distributed event store includes a command topic, and selectively subscribing, by each application, to a respective first subset of the communication topics as producers includes subscribing to the command topic as producers and publishing commands to be executed by the intelligent log driver on the command topic.

In some embodiments, the set of communication topics created by the intelligent log driver on the distributed event store includes a command topic. In some embodiments, selectively subscribing, by each application, to the respective first subset of the communication topics as producers includes subscribing to the command topic as producers and publishing commands to be executed by other applications on the command topic. In some embodiments, selectively subscribing, by each application, to the respective second subset of the communication topics as consumers includes subscribing to the command topic as consumers and receiving commands to be executed from the other applications on the command topic.

In some embodiments, the intelligent log driver and the distributed events store are implemented as part of an application programming interface to an operating system of the storage system.

In some embodiments, a common communication channel for inter-node, inter-application, and intra-application communication within a storage system, includes one or more processors and one or more storage devices storing instructions that are operable, when executed by the one or more processors, to cause the one or more processors to perform operations including creating, by an intelligent log driver, a set of communication topics on a distributed event store, subscribing, by the intelligent log driver to the set of communication topics as a consumer, producer, or both, and selectively subscribing, by each application, to a respective first subset of the communication topics as a producer on the respective first subset of communication topics, and selectively subscribing, by each application, to a respective second subset of the communication topics as a consumer on the respective second subset of communication topics. The operations further include publishing messages containing events, logs, or commands, on individual communication topics of the respective first subsets of communication topics by the applications, receiving the messages containing the events, logs, or commands, from the individual communication topics of the respective first subsets of communication topics by the intelligent log driver, and implementing commands on the storage system, by the intelligent log driver, in response to messages received from the applications on first subsets of communication topics.

In some embodiments, the distributed event store is a Kafka server.

In some embodiments, the first subset of communication topics and the second subset of communication topics at least partially overlap. In some embodiments, at least some of the applications are instantiated in different virtual machines on the storage system, and the operations further include using the communication topics to enable communication between the instances of the applications instantiated in the different virtual machines.

In some embodiments, the set of communication topics created by the intelligent log driver on the distributed event store includes an events topic. In some embodiments, selectively subscribing, by each application, to the respective first subset of the communication topics as producers includes subscribing to the events topic as producers and publishing messages on the events topic related to occurrence of events at the respective applications. In some embodiments, selectively subscribing, by each application, to the respective second subset of the communication topics as consumers includes subscribing to the events topic as consumers, reading the messages published to the events topic, and using the content of the messages published to the events topic to update respective user interface displays in accordance with the content of the messages read from the events topic.

In some embodiments, subscribing, by the intelligent log driver to the set of communication topics as a consumer includes subscribing to the events topic both as a consumer and as a producer. The operations further include determining from the messages published to the events topic that one of two instances of a given application needs to be elected as master application, and in response to determining that one of the two instances of the given application needs to be elected as the master application, publishing an election decision on the events topic to notify the two instances of the application which of the two instances has been elected the master application.

In some embodiments, the set of communication topics created by the intelligent log driver on the distributed event store includes a logs topic. In some embodiments, selectively subscribing, by each application, to the respective first subset of the communication topics as producer includes subscribing to the logs topic as producers and publishing messages containing logs related to application execution errors to the logs topic. In some embodiments, subscribing, by the intelligent log driver to the set of communication topics as a consumer includes subscribing to the logs topic as a consumer. In some embodiments, the operations further include reading the published messages containing the logs related to application execution errors by the intelligent log driver, and in response to reading the published messages, interacting by the intelligent log driver with a storage system operating system to adjust physical resources made available to the applications by the storage system.

In some embodiments, the set of communication topics created by the intelligent log driver on the distributed event store includes a command topic, and selectively subscribing, by each application, to a respective first subset of the communication topics as producers includes subscribing to the command topic as producers and publishing commands to be executed by the intelligent log driver on the command topic.

In some embodiments, the set of communication topics created by the intelligent log driver on the distributed event store includes a command topic. In some embodiments, selectively subscribing, by each application, to the respective first subset of the communication topics as producers includes subscribing to the command topic as producers and publishing commands to be executed by other applications on the command topic. In some embodiments, selectively subscribing, by each application, to the respective second subset of the communication topics as consumers includes subscribing to the command topic as consumers and receiving commands to be executed from the other applications on the command topic.

In some embodiments, the intelligent log driver and the distributed events store are implemented as part of an application programming interface to an operating system of the storage system.

### BRIEF DESCRIPTION OF THE DRAWINGS

FIG. 1 is a functional block diagram of an example storage system connected to a host computer, according to some embodiments.

FIG. 2 is a block diagram of an example set of applications executing in containers on a set of virtual machines created on an example storage system, according to some embodiments.

FIG. 3 is a block diagram of an example distributed event store implemented as a Kafka cluster, according to some embodiments.

FIG. 4 is a block diagram of an example storage system implemented to include a common communication channel for inter-node, inter-application, and intra-application communication, according to some embodiments.

FIG. 5 is a block diagram of the example storage system of FIG. 4, showing use of an events topic to communicate messages related to events between applications and between the applications and the intelligent log driver, according to some embodiments.

FIG. 6 is a flow chart of an example method of using the events topic to communicate messages related to events between applications and between the applications and the intelligent log driver, according to some embodiments.

FIG. 7 is a block diagram of the example storage system of FIG. 4, showing use of a logs topic to communicate execution logs between applications and the intelligent log driver, according to some embodiments.

FIG. 8 is a flow chart of an example method of using the logs topic to communicate execution logs between the applications and the intelligent log driver, according to some embodiments.

FIG. 9 is a block diagram of the example storage system of FIG. 4, showing use of a first command topic to communicate commands related to storage system management configuration changes from the applications to the intelligent log driver, according to some embodiments.

FIG. 10 is a flow chart of an example method of using the first command topic to communicate commands related to storage system management configuration changes from the applications to the intelligent log driver, according to some embodiments.

FIG. 11 is a block diagram of the example storage system of FIG. 4, showing use of a second command topic to communicate commands between applications and between the applications and the intelligent log driver, according to some embodiments.

FIG. 12 is a flow chart of an example method of using the second command topic to communicate commands between applications and between the applications and the intelligent log driver, according to some embodiments.

FIG. 13 is a block diagram of the example storage system of FIG. 4, showing use of a miscellaneous topic to communicate messages between applications and between the applications and the intelligent log driver, according to some embodiments.

FIG. 14 is a flow chart of an example method of using the miscellaneous topic to communicate messages between applications and between the applications and the intelligent log driver, according to some embodiments.

### DETAILED DESCRIPTION

Aspects of the inventive concepts will be described as being implemented in a storage system 100 connected to a host computer 102. Such implementations should not be viewed as limiting. Those of ordinary skill in the art will recognize that there are a wide variety of implementations of the inventive concepts in view of the teachings of the present disclosure.

Some aspects, features and implementations described herein may include machines such as computers, electronic components, optical components, and processes such as computer-implemented procedures and steps. It will be apparent to those of ordinary skill in the art that the computer-implemented procedures and steps may be stored as computer-executable instructions on a non-transitory tangible computer-readable medium. Furthermore, it will be understood by those of ordinary skill in the art that the computer-executable instructions may be executed on a variety of tangible processor devices, i.e., physical hardware. For ease of exposition, not every step, device or component that may be part of a computer or data storage system is described herein. Those of ordinary skill in the art will recognize such steps, devices, and components in view of the teachings of the present disclosure and the knowledge generally available to those of ordinary skill in the art. The corresponding machines and processes are therefore enabled and within the scope of the disclosure.

The terminology used in this disclosure is intended to be interpreted broadly within the limits of subject matter eligibility. The terms “logical” and “virtual” are used to refer to features that are abstractions of other features, e.g., and without limitation, abstractions of tangible features. The term “physical” is used to refer to tangible features, including but not limited to electronic hardware. For example, multiple virtual computing devices could operate simultaneously on one physical computing device. The term “logic” is used to refer to special purpose physical circuit elements, firmware, and/or software implemented by computer instructions that are stored on a non-transitory tangible computer-readable medium and implemented by multi-purpose tangible processors, and any combinations thereof.

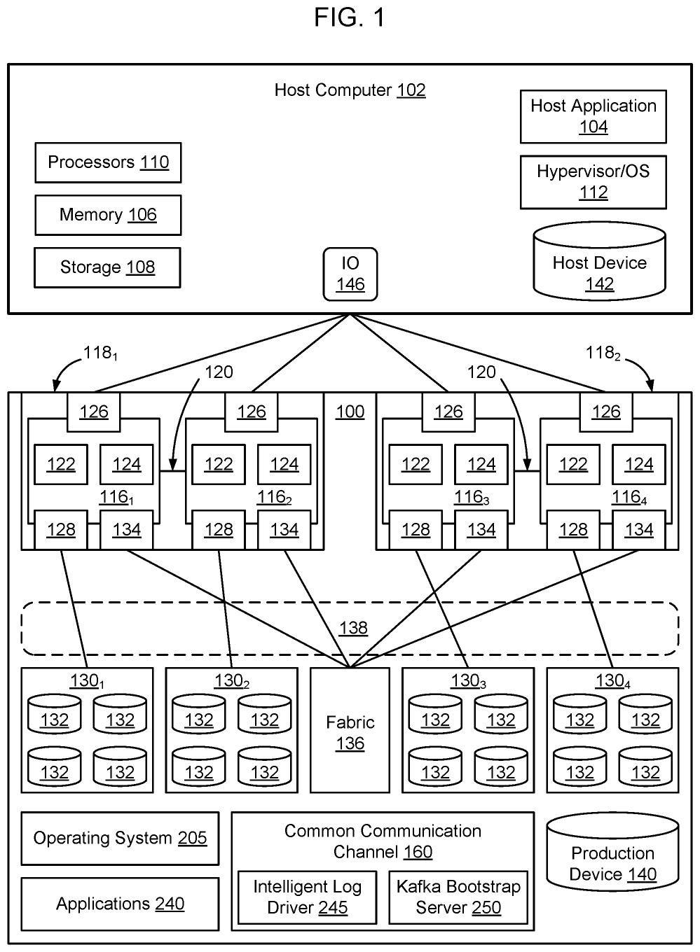

FIG. 1 illustrates a storage system 100 and an associated host computer 102, of which there may be many. The storage system 100 provides data storage services for a host application 104, of which there may be more than one instance and type running on the host computer 102. In the illustrated example, the host computer 102 is a server with host volatile memory 106, persistent storage 108, one or more tangible processors 110, and a hypervisor or OS (Operating System) 112. The processors 110 may include one or more multi-core processors that include multiple CPUs (Central Processing Units), GPUs (Graphics Processing Units), and combinations thereof. The host volatile memory 106 may include RAM (Random Access Memory) of any type. The persistent storage 108 may include tangible persistent storage components of one or more technology types, for example and without limitation SSDs (Solid State Drives) and HDDs (Hard Disk Drives) of any type, including but not limited to SCM (Storage Class Memory), EFDs (Enterprise Flash Drives), SATA (Serial Advanced Technology Attachment) drives, and FC (Fibre Channel) drives. The host computer 102 might support multiple virtual hosts running on virtual machines or containers. Although an external host computer 102 is illustrated in FIG. 1, in some embodiments host computer 102 may be implemented as a virtual machine within storage system 100.

The storage system 100 includes a plurality of compute nodes 116₁-116₄, possibly including but not limited to storage servers and specially designed compute engines or storage directors for providing data storage services. In some embodiments, pairs of the compute nodes, e.g. (116₁-116₂) and (116₃-116₄), are organized as storage engines 118₁ and 118₂, respectively, for purposes of facilitating failover between compute nodes 116 within storage system 100. In some embodiments, the paired compute nodes 116 of each storage engine 118 are directly interconnected by communication links 120. In some embodiments, the communication links 120 are implemented as a PCIe NTB. As used herein, the term “storage engine” will refer to a storage engine, such as storage engines 118₁ and 118₂, which has a pair of (two independent) compute nodes, e.g. (116₁-116₂) or (116₃-116₄). A given storage engine 118 is implemented using a single physical enclosure and provides a logical separation between itself and other storage engines 118 of the storage system 100. A given storage system 100 may include one storage engine 118 or multiple storage engines 118.

Each compute node, 116₁, 116₂, 116₃, 116₄, includes processors 122 and a local volatile memory 124. The processors 122 may include a plurality of multi-core processors of one or more types, e.g., including multiple CPUs, GPUs, and combinations thereof. The local volatile memory 124 may include, for example and without limitation, any type of RAM. Each compute node 116 may also include one or more front-end adapters 126 for communicating with the host computer 102. Each compute node 116₁-116₄ may also include one or more back-end adapters 128 for communicating with respective associated back-end drive arrays 130₁-130₄, thereby enabling access to managed drives 132. A given storage system 100 may include one back-end drive array 130 or multiple back-end drive arrays 130.

In some embodiments, managed drives 132 are storage resources dedicated to providing data storage to storage system 100 or are shared between a set of storage systems 100. Managed drives 132 may be implemented using numerous types of memory technologies for example and without limitation any of the SSDs and HDDs mentioned above. In some embodiments the managed drives 132 are implemented using NVM (Non-Volatile Memory) media technologies, such as NAND-based flash, or higher-performing SCM (Storage Class Memory) media technologies such as 3D XPoint and ReRAM (Resistive RAM). Managed drives 132 may be directly connected to the compute nodes 116₁-116₄, using a PCIe (Peripheral Component Interconnect Express) bus or may be connected to the compute nodes 116₁-116₄, for example, by an IB (InfiniBand) bus or fabric.

In some embodiments, each compute node 116 also includes one or more channel adapters 134 for communicating with other compute nodes 116 directly or via an interconnecting fabric 136. An example interconnecting fabric 136 may be implemented using PCIe (Peripheral Component Interconnect Express) or InfiniBand. Each compute node 116 may allocate a portion or partition of its respective local volatile memory 124 to a global memory 138 that can be accessed by other compute nodes 116 over the PCIe NTB links.

The storage system 100 maintains data for the host applications 104 running on the host computer 102. For example, host application 104 may write data of host application 104 to the storage system 100 and read data of host application 104 from the storage system 100 in order to perform various functions. Examples of host applications 104 may include but are not limited to file servers, email servers, block servers, and databases.

Logical storage devices are created and presented to the host application 104 for storage of the host application 104 data. For example, as shown in FIG. 1, a production device 140 and a corresponding host device 142 are created to enable the storage system 100 to provide storage services to the host application 104.

The host device 142 is a local (to host computer 102) representation of the production device 140. Multiple host devices 142, associated with different host computers 102, may be local representations of the same production device 140. The host device 142 and the production device 140 are abstraction layers between the managed drives 132 and the host application 104. From the perspective of the host application 104, the host device 142 is a single data storage device having a set of contiguous fixed-size LBAs (Logical Block Addresses) on which data used by the host application 104 resides and can be stored. However, the data used by the host application 104 and the storage resources available for use by the host application 104 may actually be maintained by the compute nodes 116₁-116₄ at non-contiguous addresses (tracks) on various different managed drives 132 on storage system 100.

In some embodiments, the storage system 100 maintains metadata that indicates, among various things, mappings between the production device 140 and the locations of extents of host application data in the global memory 138 and the managed drives 132. In response to an IO (Input/Output command) 146 from the host application 104 to the host device 142, the hypervisor/OS 112 determines whether the IO 146 can be serviced by accessing the host volatile memory 106. If that is not possible, then the IO 146 is sent to one of the compute nodes 116 to be serviced by the storage system 100.

In the case where IO 146 is a read command, the storage system 100 uses metadata to locate the commanded data, e.g., in the global memory 138 or on managed drives 132. If the commanded data is not in the global memory 138, then the data is temporarily copied into the global memory 138 from the managed drives 132 and sent to the host application 104 by the front-end adapter 126 of one of the compute nodes 116₁-116₄. In the case where the IO 146 is a write command, in some embodiments the storage system 100 copies a block being written into the global memory 138, marks the data as dirty, and creates new metadata that maps the address of the data on the production device 140 to a location to which the block is written on the managed drives 132.

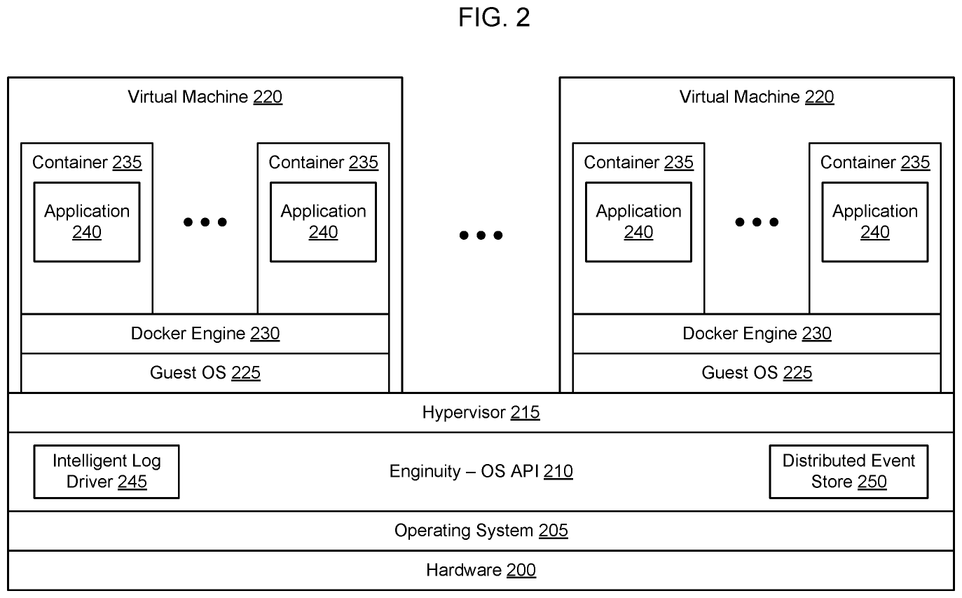

FIG. 2 is a block diagram of an example set of applications executing in containers on a set of virtual machines created on an example storage system, according to some embodiments. As shown in FIG. 2, in some embodiments a storage system 100 includes hardware elements 200 such as the hardware elements described in connection with FIG. 1. An Operating System (OS) 205 runs on the hardware 200 to control operation of the hardware. A hypervisor 215 runs as an application on the operating system to abstract the hardware resources of hardware layer 200 from emulations implemented as virtual machines 220. In some embodiments, an application described herein as an Operating System API 210 is provided to implement actions on behalf of applications 240 executing within the virtual machines 220 to configure the resources of the storage system 100. For example, the underlying storage resources provided by the hardware layer 200 may be configured using the OS API 210, such as by instructing the operating system to create storage groups, storage volumes, implement remote data replication, and myriad other operations. The OS API 210, accordingly, in some embodiments is responsible for implementing actions on behalf of the applications 240 to configure operation of the storage system 100. An example OS API is referred to herein as Enginuity, which is provided by Dell™. It should be understood that other OS APIs may be used to interact with the storage system as well and Enginuity is described merely as one example OS API.

Multiple applications 240 may be executing on a storage system. As shown in FIG. 2, in some embodiments virtual machines include a guest operating system 225 and one or more applications 240. The applications may be stand-alone applications, or may be deployed as containerized applications 240 in containers 235 on a container platform 230. In FIG. 2 an example container platform is shown as a docker engine 230 supporting containers 235. It should be understood that other types of containers/platforms may be used as well, depending on the implementation.

Conventionally, different instances of the same type of application 240 and different types of applications 240 communicated with each using multiple types of communications channels/protocols. For example, a storage system management application may use an operating system utility API to issue configuration commands to the OS API 210 to implement configuration changes on the storage system, whereas a storage application (referred to herein as a “file application”) may use a REST API of the storage system management application to implement the same types of operations. Similarly, when events happen, the storage system management application may pull the events from the file applications on demand. Within the file application, one or more software defined network attached storage (SDNAS) instances may be executing, and the file application pulls events from the SDNAS instances on demand. Thus, there are many types of communication channels/protocols, which can make deployment of additional services challenging.

Additionally, applications also may use an altogether different approach when interacting directly with the hypervisor for guest/virtual machine operations, e.g., to adjust the type or quantity of resources provided to the by the hypervisor 215 to the virtual machine hosting the application. For example, an application may need an additional storage volume to be created and mapped to the application in the container. The multiple types of communication adds overhead, which makes developing new functionality difficult.

Further, many applications within the storage system must operate in a High-Availability (HA) environment, such that multiple instances of the same type of application are operational at any given point in time. When one instance of the application fails, HA ensures that the other instance is available to provide continued operation of the service provided by the application. Typically, one instance of the application will assume the role of leader and the other instances are backup instances. However, implementing an application with HA can lead to conflicts, for example in instances where one node falsely believes the other node is experiencing failure, which can lead to contention for leadership. Often, to avoid this scenario, yet additional communication is implemented between the instances of a given application, which also leads to additional overhead and may not entirely solve the split-brain problem where two nodes assert leadership, which can happen in instances where communication between the HA nodes fails.

According to some embodiments, a common communication channel 160 for inter-node, inter-application, and intra-application communication within a storage system is provided. As shown in FIG. 2, in some embodiments the common communication channel for inter-node, inter-application, and intra-application communication 160 is implemented to include an intelligent log driver 240 and a distributed event store 250. One example of a distributed event store 250 is a Kafka server or Kafka cluster. Although some embodiments are described in which the distributed event store 250 is a Kafka server/cluster, it should be understood that other types of distributed event stores may be used as well depending on the implementation.

In some embodiments, the Kafka server 250 hosts topics 305 that applications 240 subscribe to as producers, consumers, or both. The Intelligent Log Driver 245 controls creation of the topics 305 and also is a subscriber and producer on select topics 305. The Intelligent Log Driver 245 is implemented within or interacts with the storage system API 210 to implement configuration changes of the storage system based on commands received on the topics 305. By providing a common communication channel for inter-node, inter-application, and intra-application communication within a storage system, it is possible to simplify communication between applications 240, such as between a storage system management application and the underlying storage system, and between software defined network attached applications and other forms of applications resident on virtual machines on the storage system.

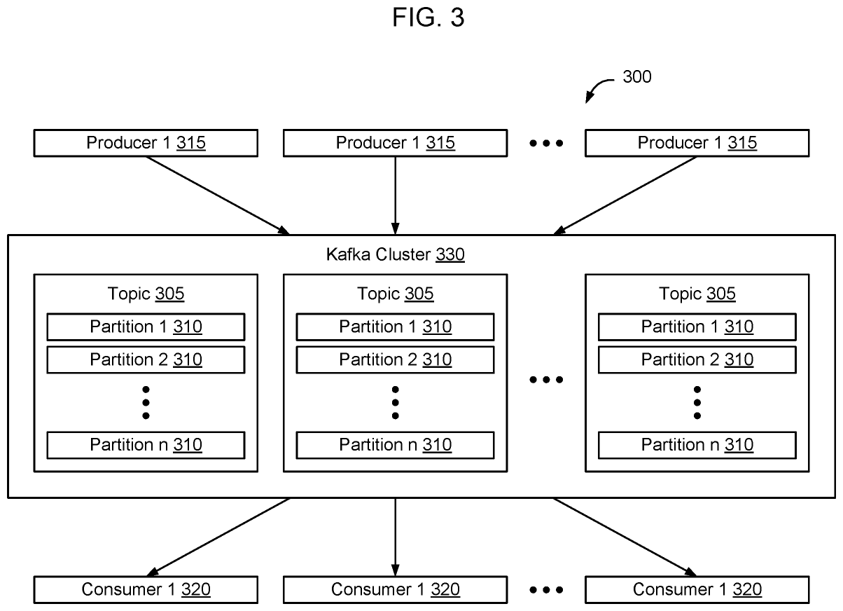

FIG. 3 is a block diagram of an example distributed event store and stream-processing platform 300 implemented as a Kafka cluster 330. Apache Kafka is an example open-source distributed event store and stream-processing platform 300. Although some embodiments are described in which the distributed event store and stream-processing platform 300 is implemented using a Kafka cluster 330, it should be understood that other types of distributed event stores and stream-processing platforms may be used depending on the particular implementation.

As shown in FIG. 3, a Kafka cluster 330 includes a number of Kafka servers configured to receive and store key-value messages that come from arbitrarily many processes called producers 315. Messages are sorted into topics 305, and data from the producers 315 can also be partitioned into different partitions 310 within the topics 305. Other processes called consumers 320 can read messages from partitions 310 within the topics 305. For example, as described in greater detail below, in some embodiments different types of applications 240 act as producers 315 on particular subsets of topics and act as consumers 320 on the same or different subsets of topics 305. The intelligent log driver 245 is responsible for creating the topics on the Kafka server 250 and also acts as a producer on particular subsets of topics and as a consumer on the same or another subset of topics. By using a Kafka server to implement a distributed event-store and stream-processing platform, it is possible to provide a common communication channel for inter-node, inter-application, and intra-application communication 160 within a storage system to simplify communication between the various applications executing in the context of the storage system. Although some embodiments are described below in which the intelligent log driver 245 is described as creating topics, it should be understood that the intelligent log driver 245 may also create partitions 310 within the topics 305 to facilitate communication within the storage system 100.

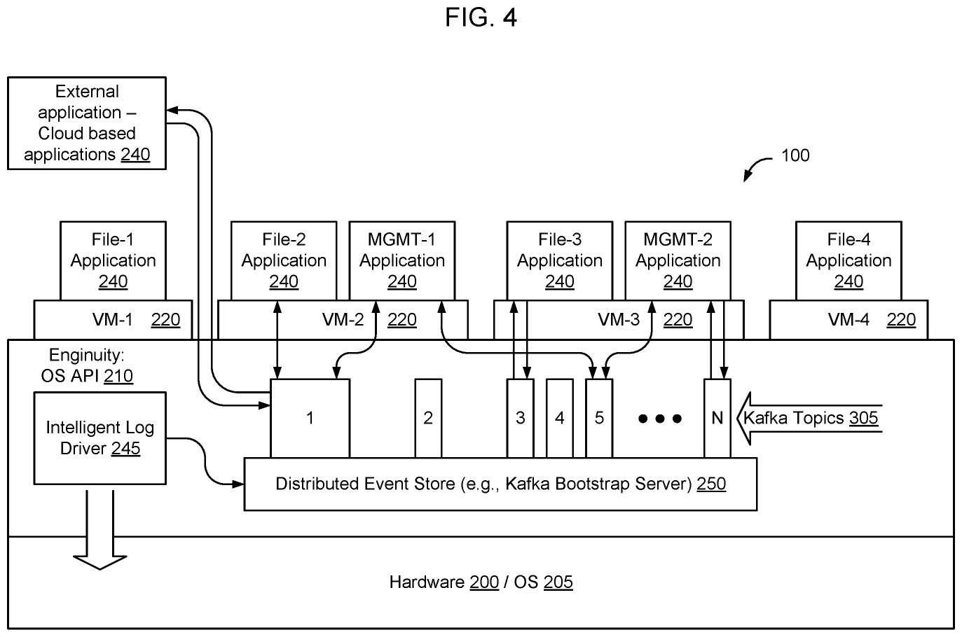

FIG. 4 is a block diagram of an example storage system 100 implemented to include a common communication channel for inter-node, inter-application, and intra-application communication, according to some embodiments. As shown in FIG. 4, in some embodiments the common communication channel includes an intelligent log driver 245 and a Kafka bootstrap server 250. Although a single Kafka server 250 is shown in FIG. 4 for ease of illustration, it should be understood that the Kafka server 250 may be implemented as a Kafka cluster 330, depending on the implementation. In some embodiments, the Kafka server 250 and the Intelligent Log Driver 245 are deployed in the OS API 210.

In some embodiments, the Kafka server 250 is deployed in the OS API 210 and is based on the Apache Kafka streaming platform. The Kafka sever hosts all the queues, which are referred to herein as “topics”. The topics are used for inter-node communication (e.g., communication between virtual machines), inter-application communication (e.g., communication between two or more different types of applications executing within a given virtual machine or on different virtual machines), or intra-application communication (e.g., communication between different instances of a given type of application executing within a given virtual machine or on different virtual machines). Multiple applications can subscribe to a particular topic or set of topics, and the applications may implement logic dependent on messages read from the same or different set of topics. For example, in FIG. 4 File-2 application 240, MGMT-1 application 240, and an external application-cloud based application, are all subscribed to topic 1. Accordingly, topic 1 provides an example of how a given topic may be used to facilitate inter-application communication. Likewise, as shown in FIG. 4, two instances of the management application (MGMT-1 and MGMT-2) are both subscribed to topic 5. Accordingly, topic 5 provides an example of how a given topic may be used to facilitate intra-application communication. MGMT-1 and MGMT-2 are also hosted on different virtual machines (nodes) and, accordingly topic 5 provides an example of how a given topic may be used to facilitate intra-node communication

The intelligent log driver 245 is a software component residing within the OS API 210 and is the single point of contact for creating/deleting topics. The topics may be manually configured or may be automatically created, for example in instances where a given topic is overloaded the intelligent log driver 245 may act to create a duplicate topic 305. The intelligent log driver 245 may also create or destroy topics on request, for example when instructed to do so by a storage system management application.

The intelligent log driver 245 is also configured to arbitrate between nodes to specify which node is a master in the context of a set of two or more redundant nodes configured to implement high-availability within the storage system. The intelligent log driver 245 subscribes to particular topics to receive messages related to configuration of the hardware resources 200 of the storage system from guest operating systems 225 and applications 240, and issues corresponding instructions to the OS API 210 to implement the requested actions on the storage system.

FIG. 4 shows an example storage system 100 in which the intelligent log driver 245 has created an example set of five Kafka topics 305, labeled:
1: Events
2: Logs
3: Command 1
4: Command 2
5: Miscellaneous

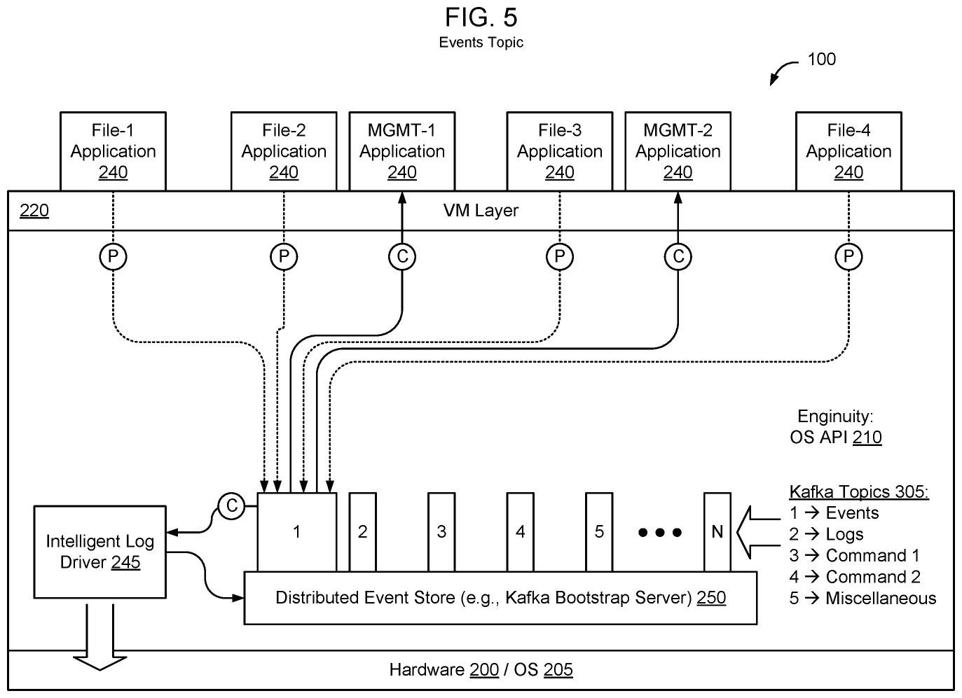

It should be understood that the set of topics shown in FIG. 4 is merely intended to provide an example, since the particular set of topics will depend on the particular implementation. FIGS. 5-14, described below, provide additional context to provide some examples which aim to illustrate how these several topics may be used in an example environment. It should be understood that these examples are not intended to be exhaustive, as the common communication channel may be used in many additional ways.

In the example shown in FIG. 4, the storage system includes four virtual machines 220, labeled VM-1 through VM-4. Each VM includes one or more applications 240. The applications 240 may be stand-alone applications or implemented in containers as described in connection with FIG. 2. Each application 240 may subscribe to particular Kafka topics as a producer, consumer, or both. Although not shown in FIG. 4, each VM includes a guest OS 225 which may also separately subscribe to particular Kafka topics as a producer, consumer, or both. Likewise, the hypervisor 215 may subscribe to particular Kafka topics as a producer, consumer, or both.

In FIG. 4, two example applications 240 are shown-File applications and management (MGMT) applications. File applications, in this context, are applications that are configured to use storage resources managed by the hardware 200. A file application may include multiple Software Defined Network Attached Storage (SDNAS) processes executing to respond to storage access requests from hosts 102. Management (MGMT) applications are applications that are configured to control operation of the storage system, for example by adjusting the manner in which the storage system provides storage resources to the file applications. Example management actions might include, for example, creating a storage volume for use by one of the file applications, increasing the size of the storage volume, causing the storage system to create a snapshot of the data contained within the storage volume, causing the storage system to mirror the data of the storage volume to a backup location, etc. There are many operations that may be implemented by the management applications and this set of example operations is merely intended to illustrate a few of the myriad operations that may be implemented.

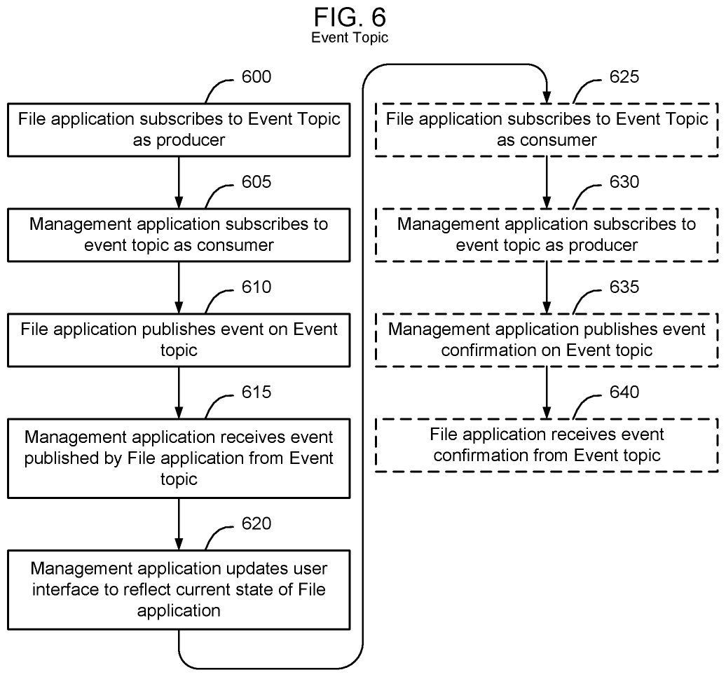

FIGS. 5-14 describe some examples of how particular selected topics may be used in an example environment to communicate between file applications and management applications. In FIGS. 5, 7, 9, 11, and 13, the letter P in a circle indicates that a particular application 240 is a producer on a topic, and the letter C in a circle indicates that the particular application is a consumer on a topic. FIGS. 6, 8, 10, 12, and 14 are flow charts describing some example methods of using the topics to communicate between the applications.

FIG. 5 is a block diagram of the example storage system of FIG. 4, showing use of an events topic (Kafka Topic #1) to communicate messages related to events between applications and between the applications and the intelligent log driver 245, according to some embodiments. As shown in FIG. 5, in some instances file applications (File-1, File-2, File-3, and File-4 in FIG. 5) subscribe to the events topic (Kafka Topic #1) as producers to enable the file applications to post messages related to occurrence of events. Instances of the management application (MGMT-1 and MGMT-2 in FIG. 5) subscribe to the events topic (Kafka Topic #1) as consumers. When an event occurs in one of the File Applications, the file application creates a message describing the event and posts the message to the event topic. The management applications read messages from the event topic and use the content of the messages to update displays on their corresponding graphical user interfaces. In instances where the management applications contain logic to implement particular actions in response to occurrence/notification of particular events, the management applications may post subsequent commands to command topic 3 or 4 (as described below) to instruct the intelligent log driver 245 to take corrective action in response to occurrence of the event. Optionally, the intelligent log driver 245 may also subscribe as a consumer on the events topic. In this manner, events that occur within the file applications 240 may be automatically communicated to the management applications and optionally to the intelligent log driver 245. Although not shown in FIG. 5, the management applications can also subscribe to the event topic to post events, for example to enable communication between instances of the management application and to communicate events from the management application to the file applications. Optionally communication from the file applications to the management applications may occur on a particular partition within the event topic, and communication from the management application to the file applications may occur on a separate partition within the event topic, depending on the implementation.

FIG. 6 is a flow chart of an example method of using the events topic (Kafka topic #1) to communicate messages related to events between applications and between the applications and the intelligent log driver, according to some embodiments. As shown in FIG. 6, in some embodiments a file application subscribes to an event topic #1 as a producer (block 600) and a management application subscribes to the event topic #1 as a consumer (block 605). Upon occurrence of an event, the file application publishes an event as a message on the event topic #1 (block 610). The management application receives the event, by reading the message from the event topic (block 615). In response to reading the message from the event topic #1, the management application updates its user interface to reflect the current state of the file application, as reflected by the content of the event message (block 620). In this manner, events that occur on the file applications are able to be communicated to the instances of the management application and reflected in the user interface of the management application.

Similarly, the management application may use the topic to publish other events to the file applications to instruct the file applications to take particular actions in response to instructions from the management application. For example, optionally, as shown by use of the dashed blocks of FIG. 6, the file application may also subscribe to the event topic #1 as a consumer (block 625) and the management application may also subscribe to the event topic #1 as a producer (block 630). Upon receipt of the event by the management application, the management application may publish an event confirmation on the event topic #1 (block 635). The file application then reads the event confirmation from the event topic #1 (block 640). Use of the event topic #1 in this manner may thus enable the file application to verify that the event has been received by the management application. In some embodiments, a separate topic may be used to implement communication from the management application to the file applications (blocks 625-640).

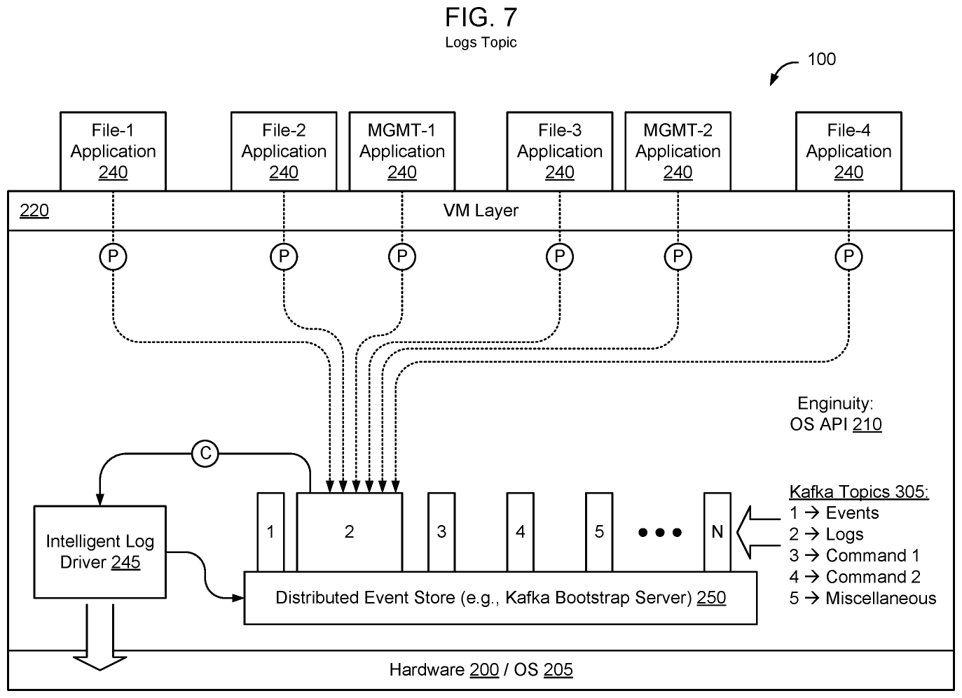

FIG. 7 is a block diagram of the example storage system of FIG. 4, showing use of a logs topic (Kafka topic #2) to communicate execution logs between applications and the intelligent log driver, according to some embodiments. As shown in FIG. 7, all types of applications (both file applications and management applications in this example), as well as guest operating systems, can post logs generated by internal processing/dependent processing to the log topic #2. Applications generate logs as they execute to implement operations on the storage system. The execution logs may be quite extensive, such that publishing all logs by a given application might flood the Kafka topic with excessive information. According to some embodiments, applications only publish logs to the log topic in response to determination that are relevant to occurrence of a relatively serious error, e.g., warning, emergency, and critical errors. By providing a logs topic, it is possible for an application to publish its logs upon occurrence of a serious error, which makes the logs available to the intelligent log driver 245 so that the intelligent log driver 245 can take corrective action or make an informed decision as to which of several applications should execute particular tasks on the storage system.

As a first example use of the logs topic, assume that during execution a file application publishes a log indicating that memory usage has reached an 80% threshold. If the file application publishes the same log (80% memory usage warning) multiple times within a short duration of time, the intelligent log driver 245 can scale up the memory resource of the virtual machine on which the application is executing, to increase the amount of memory provided to the VM. As another example use of the logs topic, during a communication failure between two file applications, a log indicating that communication with one of the two file applications has failed enables the intelligent log driver 245 to make a decision as to which of the two file applications should be halted. In an environment in which the two applications are configured as backup applications, to provide high availability, having the intelligent log driver 245 make a decision as to which file application should be the master based on the logs published by the instances of the application, prevents the scenario where both of the two file applications attempts to assume the role of master.

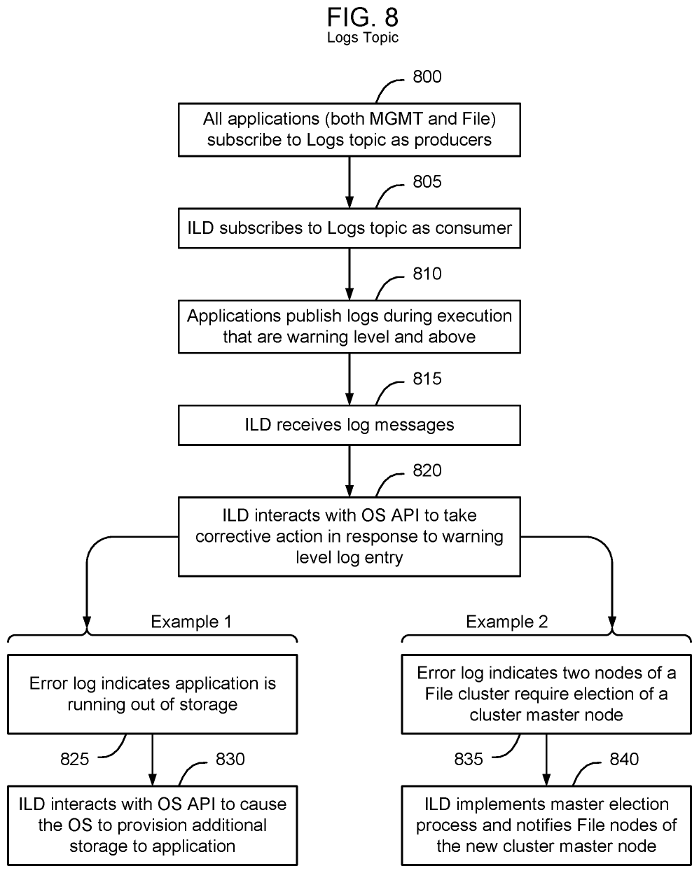

FIG. 8 is a flow chart of an example method of using the logs topic (Kafka topic #2) to communicate execution logs between the applications and the intelligent log driver, according to some embodiments. As shown in FIG. 8, in some embodiments all applications, both management applications and file applications, subscribe to the logs topic #2 as producers (block 800). The intelligent log driver 245 subscribes to the logs topic #2 as a consumer (block 805). Applications publish logs during execution that are warning level and above as messages on the logs topic #2 (block 810). The intelligent log driver 245 reads messages from the logs topic #2 (block 815). The intelligent log driver contains logic configured to cause it to interact with the operating system API 210 in response to receipt of particular logs or determination of particular log patterns (block 820).

FIG. 8 provides two example execution patterns showing two example actions that the intelligent log driver 245 may execute in response to receipt of particular log messages, depending on the implementation. As a first example, in response to a determination by the intelligent log driver 245 that the error log indicates an application is running out of storage (block 825), the intelligent log driver interacts with the operating system API to cause the OS to provision additional storage to the application (block 830). As a second example, in response to a determination by the intelligent log driver 245 that two nodes of a file cluster require election of a cluster master node (block 835), the intelligent log driver 245 implements a master election process and notifies the file nodes of the new cluster master node by publishing the result of the master node election process on one of the Kafka topics 305 (block 840).

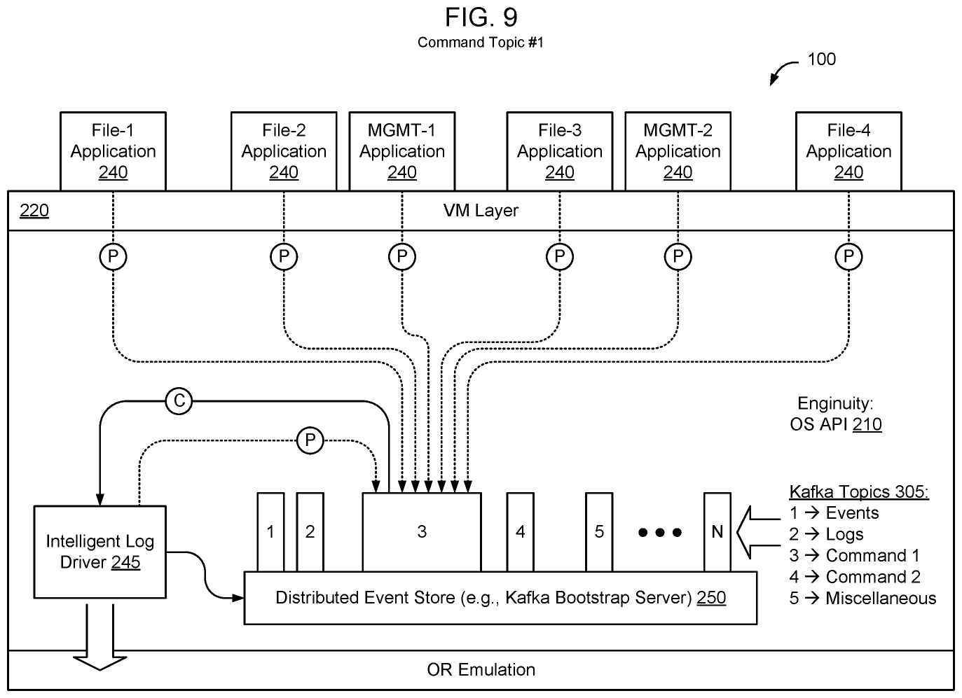

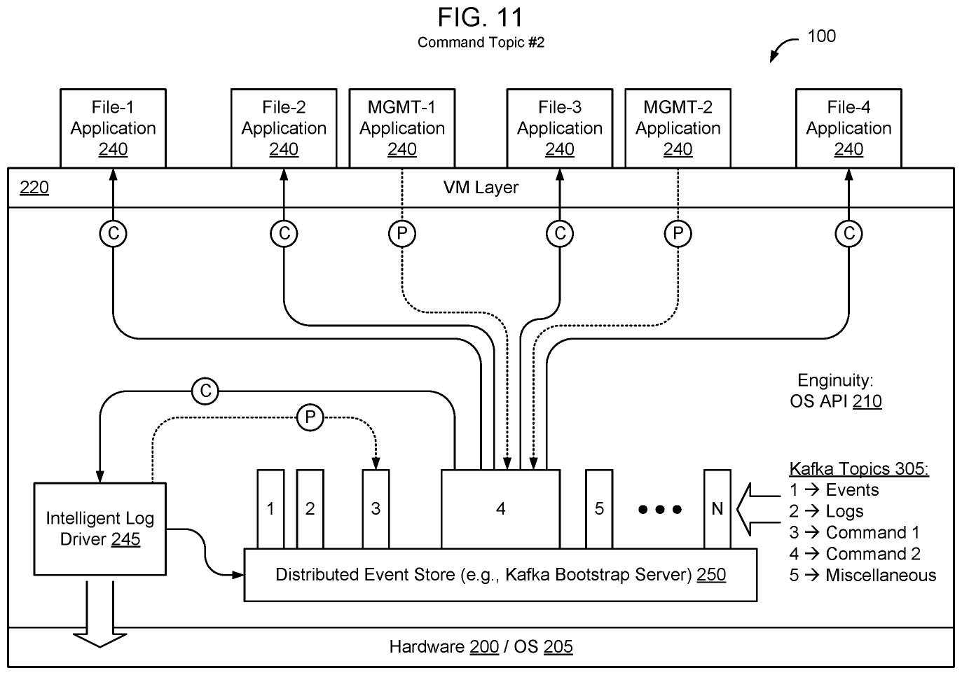

FIG. 9 is a block diagram of the example storage system of FIG. 4, showing use of a third command topic (Kafka topic #3) to communicate commands related to storage system management configuration changes from the applications to the intelligent log driver, according to some embodiments. As shown in FIGS. 9 and 11, there may be more than one command topic to address the needs of the applications/nodes. The goal of these topics is for the applications and guest operating systems to publish commands to the intelligent log driver, to cause the intelligent log driver to implement the commands. The intelligent log driver may implement the commands posted to the command topic #3 either through the operating system API 210 or by issuing the command to a different guest OS or to a different application.

In some embodiments, different commands topics may be created for different types of commands. For example, a first command topic may be created and used by applications to post commands to the Intelligent log driver 245 related to creation and management of storage or other storage related actions. Another command topic may be created and used to enable the management applications to issue commands to the file applications. Some commands may be synchronous, while other commands may be asynchronous. Both types of commands may be handled similarly, by submitting commands on a first command topic and waiting for a response on a different command topic. Further, in some embodiments if the intelligent log driver 245 determines that there is excessive traffic on a given topic, it is possible for the intelligent log driver 245 to create an additional instance of the topic.

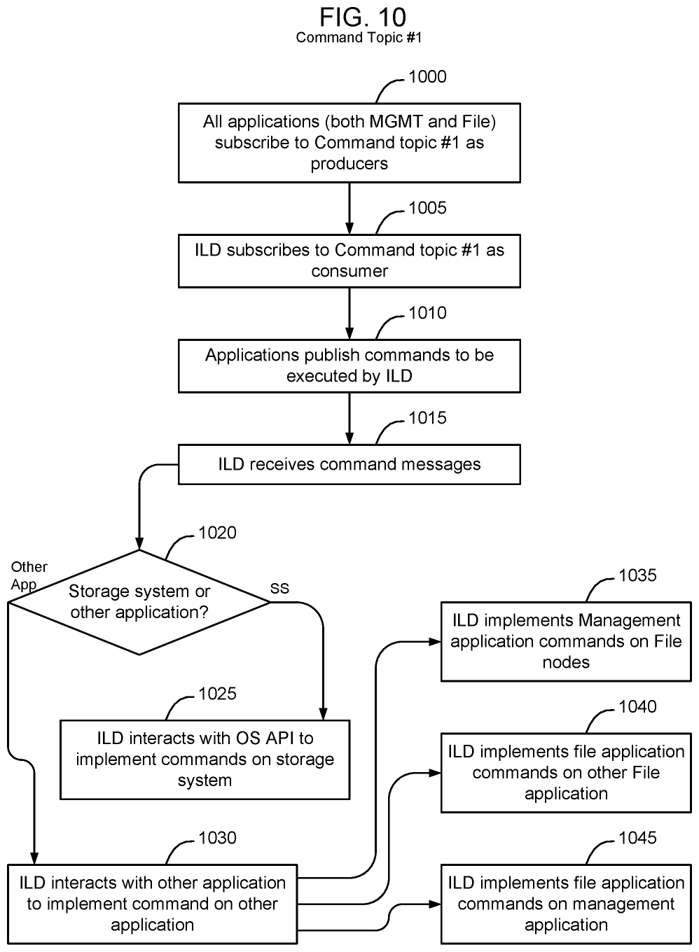

FIG. 10 is a flow chart of an example method of using the first command topic (Kafka topic #3) to communicate commands related to storage system management configuration changes from the applications to the intelligent log driver, according to some embodiments. As shown in FIG. 10, in some embodiments all applications (both management and file applications) subscribe to a first command topic as producers (block 1000). The intelligent log driver 245 subscribes to the first command topic as a consumer (block 1005). Applications publish commands to be executed by the intelligent log driver (block 1010). In some embodiments, the intelligent log driver 245 receives a command from the command topic (block 1015) and determines if execution of the command needs to be implemented by the storage system or by another application executing on the storage system (block 1020). In response to a determination that the command needs to be implemented by the storage system, the intelligent log driver 245 interacts with the storage system operating system via the OS API 210 to implement the commands on the storage system (block 1025).

In response to a determination that the command needs to be implemented by another application, the intelligent log driver 245 interacts with the other application to implement the command on the other application (block 1030). In some embodiments, applications such as the file application and management applications subscribe to command topics as consumers and the intelligent log driver instructs the application to implement the command by posting a message on the command topic subscribed to by the relevant application. This enables the intelligent log driver 245 to implement management application commands on file applications (block 1035), enables the intelligent log driver 245 to implement file application commands on other file applications (block 1040), and enables the intelligent log driver 245 to implement file application commands on the management application (block 1045).

Commands submitted by an application on a given command topic (such as Kafka topic #4) may be related to a particular instance of an application, a group of applications, all applications of a given type, or all applications. For example, a management application might submit a command to the command topic that is intended to be implemented on a particular file application, on a group of file applications, or on all file applications.

FIG. 11 is a block diagram of the example storage system of FIG. 4, showing use of a second command topic (Kafka topic #4) to communicate commands directly between applications. In the example shown in FIG. 11, the commands submitted on the second command topic are also monitored by the intelligent log driver, by having the intelligent log driver subscribe to the second command topic as a consumer. As shown in FIG. 11, in the illustrated example the second command topic is used by the management applications to transmit commands to the file applications. Accordingly, the management applications have subscribed to the second command topic (Kafka topic #4) as producers, and the file applications have subscribed to the second command topic as consumers. When a management application would like to execute a particular command on a given file application, on a set of file applications, or on all file applications, it submits the command to the second command topic (Kafka topic #4). Each file application reads messages from the second command topic. In response to a determination that the message is addressed to itself, a given file application will implement the command. Optionally the file application may post confirmation of receipt of the command and/or confirmation that the command has been implemented on the same topic or on a different topic. For example, as actions are implemented in response to the commands, the actions may be reported on the logs topic (Kafka topic #2) or on the miscellaneous topic (Kafka topic #5).

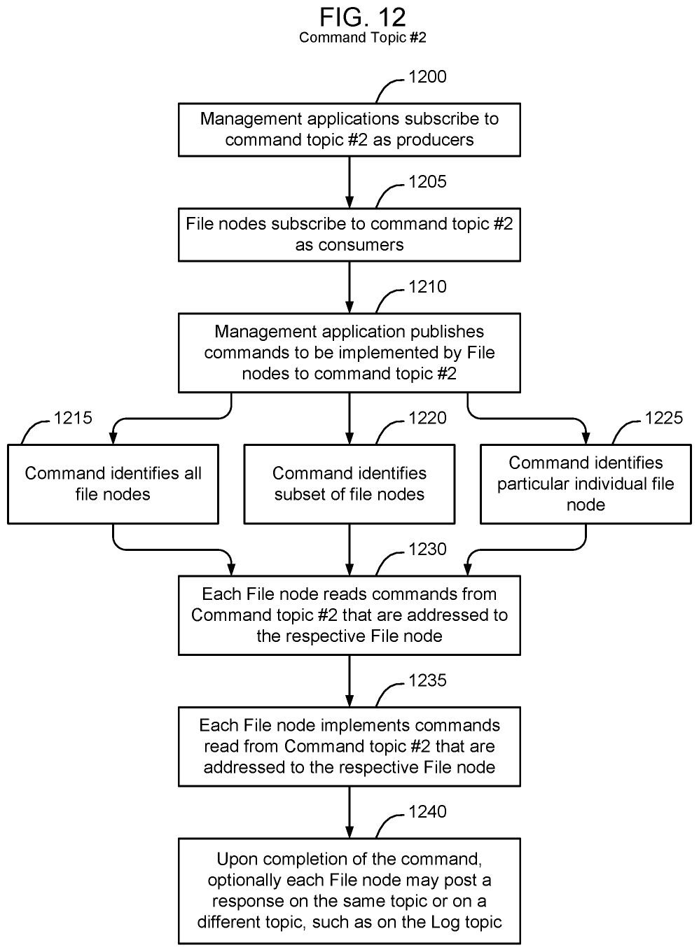

FIG. 12 is a flow chart of an example method of using the second command topic (Kafka topic #4) to communicate commands between applications and between the applications and the intelligent log driver, according to some embodiments. As shown in FIG. 12, in some embodiments, management applications subscribe to command topic #2 as producers (block 1200) and the file applications subscribe to command topic #2 as consumers (block 1205). The management applications publish messages containing commands to be implemented by the file applications to the command topic #2 (block 1210). The messages may identify all file applications (block 1215), a subset of the file applications (block 1220), or a particular individual file application (block 1225).

Each file application reads commands from the command topic #2 that are addressed to the respective file application (block 1230). Each file application implements commands read from the command topic #2 that are addressed to the respective file application (block 1235). Upon completion of the command, optionally each file application may post a response on the same topic or on a different topic, such as the log topic, confirming implementation of the submitted command (block 1240).

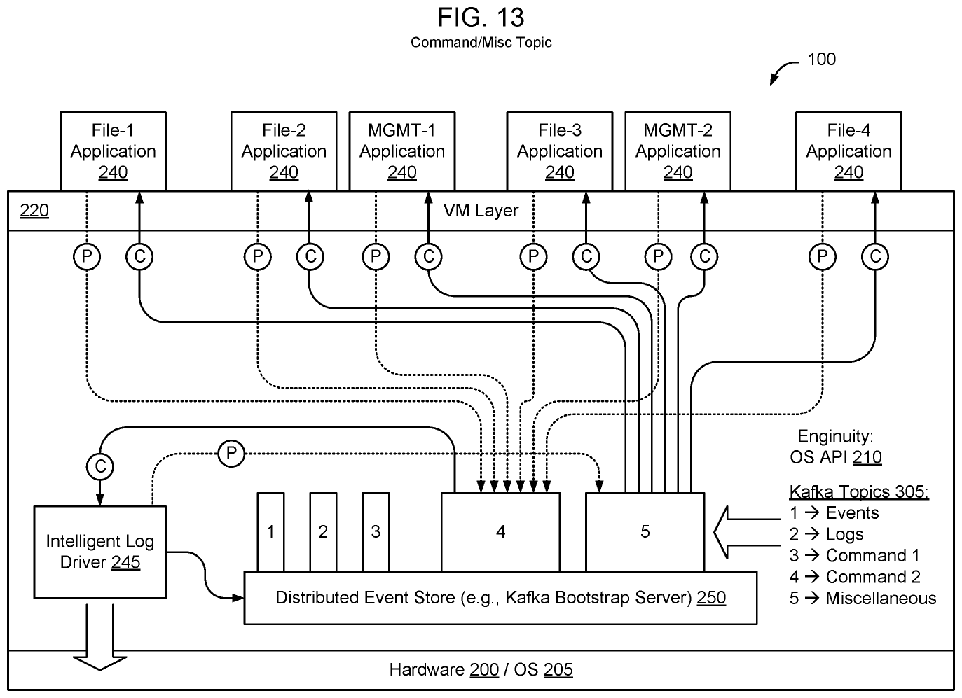

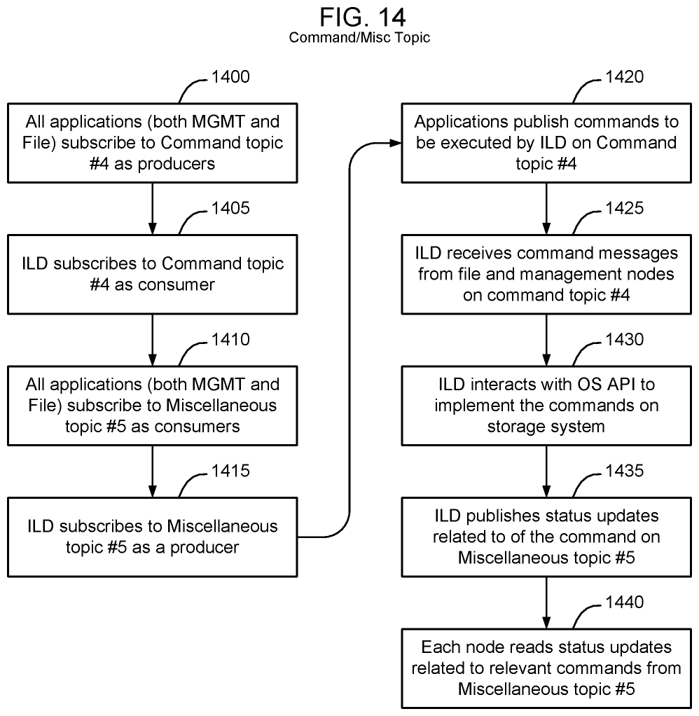

FIG. 13 is a block diagram of the example storage system of FIG. 4, showing use of a miscellaneous topic (Kafka topic #5) to communicate messages between applications and between the applications and the intelligent log driver, according to some embodiments. FIG. 13 shows some embodiments in which the message flow from applications 240 to the intelligent log driver 245 uses a first Kafka topic (Kafka topic #4 in this example), while the message flow from the intelligent log driver 245 to the applications 240 uses a second Kafka topic (Kafka topic #5 in this example). Specifically, as shown in FIG. 13, each application instance subscribes to Kafka topic #4 as a producer (FIG. 14, block 1400), and the intelligent log driver 245 subscribes to Kafka topic #4 as a consumer (FIG. 14, block 1405). Each application instance also subscribes to Kafka topic #5 as a consumer (FIG. 14, block 1410), and the intelligent log driver 245 subscribes to Kafka topic #5 as a producer (FIG. 14, block 1415). Communications are submitted by the applications on Kafka topic #4 (FIG. 14, block 1420), received by the intelligent log driver 245 (FIG. 14, block 1425), implemented by the intelligent log driver 245 (FIG. 14, block 1430), and responses to the communications are submitted by the intelligent log driver 245 on Kafka topic #5 (FIG. 14, block 1435). Each application reads status updates related to relevant commands from the Kafka topic #5 (FIG. 14, block 1440).

By using a common communication channel for inter-node, inter-application, and intra-application communication within a storage system, applications no longer need to incur overhead associated with having different communication endpoints for different purposes. Specifically, by implementing a set of topics for different purposes, it is possible to use a single communication system to enable multiple disparate instances of applications to communicate with each other and to communicate with the underlying storage system to implement operations on the storage system. Further, by including a logs topic, it is possible for all applications/nodes to publish logs and events to a common location. This can help with the quick resolution of issues which can arise in connection with dependent component failures. In some embodiments, back tracing the event and log files enables external resolution of errors by serializing the occurrence of the events with the logs, particularly in instances where the messages posted to the various topics are all timestamped.

Use of a common communication channel also helps unify the communication channel between different components, which can drastically reduce the amount of overhead required to achieve different functionalities. Likewise, when new features are developed, not requiring communication coordination reduces the amount of work required to develop the new feature in a given application, since communication associated with the new feature is able to be simplified to determining what messages need to be posted by the new feature to an existing topic or to a new topic, and is simplified to determining what messages need to be consumed from a new or existing topic.

The methods described herein may be implemented as software configured to be executed in control logic such as contained in a CPU (Central Processing Unit) or GPU (Graphics Processing Unit) of an electronic device such as a computer. In particular, the functions described herein may be implemented as sets of program instructions stored on a non-transitory tangible computer readable storage medium. The program instructions may be implemented utilizing programming techniques known to those of ordinary skill in the art. Program instructions may be stored in a computer readable memory within the computer or loaded onto the computer and executed on computer's microprocessor. However, it will be apparent to a skilled artisan that all logic described herein can be embodied using discrete components, integrated circuitry, programmable logic used in conjunction with a programmable logic device such as a FPGA (Field Programmable Gate Array) or microprocessor, or any other device including any combination thereof. Programmable logic can be fixed temporarily or permanently in a tangible non-transitory computer readable medium such as random-access memory, a computer memory, a disk drive, or other storage medium. All such embodiments are intended to fall within the scope of the present invention.

Throughout the entirety of the present disclosure, use of the articles “a” or “an” to modify a noun may be understood to be used for convenience and to include one, or more than one of the modified noun, unless otherwise specifically stated. The term “about” is used to indicate that a value includes the standard level of error for the device or method being employed to determine the value. The use of the term “or” in the claims is used to mean “and/or” unless explicitly indicated to refer to alternatives only or the alternatives are mutually exclusive, although the disclosure supports a definition that refers to only alternatives and to “and/or.” The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and also covers other unlisted steps.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

1. A method of using a common communication channel for inter-node, inter-application, and intra-application communication within a storage system, the method comprising:
creating, by an intelligent log driver, a set of communication topics on a distributed event store;
subscribing, by the intelligent log driver to the set of communication topics as a consumer, producer, or both;
selectively subscribing, by each application, to a respective first subset of the communication topics as a producer on the respective first subset of communication topics, and selectively subscribing, by each application, to a respective second subset of the communication topics as a consumer on the respective second subset of communication topics;
publishing messages containing events, logs, or commands, on individual communication topics of the respective first subsets of communication topics by the applications;
receiving the messages containing the events, logs, or commands, from the individual communication topics of the respective first subsets of communication topics by the intelligent log driver; and
implementing commands on the storage system, by the intelligent log driver, in response to messages received from the applications on first subsets of communication topics.

2. The method of claim 1, wherein the distributed event store is a Kafka server.

3. The method of claim 1, wherein the first subset of communication topics and the second subset of communication topics at least partially overlap.

4. The method of claim 3, wherein at least some of the applications are instantiated in different virtual machines on the storage system;
the method further comprising using the communication topics to enable communication between the instances of the applications instantiated in the different virtual machines.

5. The method of claim 1, wherein the set of communication topics created by the intelligent log driver on the distributed event store includes an events topic;
wherein selectively subscribing, by each application, to the respective first subset of the communication topics as producers comprises subscribing to the events topic as producers and publishing messages on the events topic related to occurrence of events at the respective applications; and
wherein selectively subscribing, by each application, to the respective second subset of the communication topics as consumers comprises subscribing to the events topic as consumers, reading the messages published to the events topic, and using the content of the messages published to the events topic to update respective user interface displays in accordance with the content of the messages read from the events topic.

6. The method of claim 5, wherein subscribing, by the intelligent log driver to the set of communication topics as a consumer comprises subscribing to the events topic both as a consumer and as a producer;
the method further comprising:
determining from the messages published to the events topic that one of two instances of a given application needs to be elected as master application; and
in response to determining that one of the two instances of the given application needs to be elected as the master application, publishing an election decision on the events topic to notify the two instances of the application which of the two instances has been elected the master application.

7. The method of claim 1, wherein the set of communication topics created by the intelligent log driver on the distributed event store includes a logs topic;
wherein selectively subscribing, by each application, to the respective first subset of the communication topics as producer comprises subscribing to the logs topic as producers and publishing messages containing logs related to application execution errors to the logs topic; and
wherein subscribing, by the intelligent log driver to the set of communication topics as a consumer comprises subscribing to the logs topic as a consumer;
the method further comprising:
reading the published messages containing the logs related to application execution errors by the intelligent log driver; and
in response to reading the published messages, interacting by the intelligent log driver with a storage system operating system to adjust physical resources made available to the applications by the storage system.

8. The method of claim 1, wherein the set of communication topics created by the intelligent log driver on the distributed event store includes a command topic; and
wherein selectively subscribing, by each application, to a respective first subset of the communication topics as producers comprises subscribing to the command topic as producers and publishing commands to be executed by the intelligent log driver on the command topic.

9. The method of claim 1, wherein the set of communication topics created by the intelligent log driver on the distributed event store includes a command topic;
wherein selectively subscribing, by each application, to the respective first subset of the communication topics as producers comprises subscribing to the command topic as producers and publishing commands to be executed by other applications on the command topic; and
wherein selectively subscribing, by each application, to the respective second subset of the communication topics as consumers comprises subscribing to the command topic as consumers and receiving commands to be executed from the other applications on the command topic.

10. The method of claim 1, wherein the intelligent log driver and the distributed events store are implemented as part of an application programming interface to an operating system of the storage system.

11. A common communication channel for inter-node, inter-application, and intra-application communication within a storage system, comprising:
one or more processors and one or more storage devices storing instructions that are operable, when executed by the one or more processors, to cause the one or more processors to perform operations comprising:
creating, by an intelligent log driver, a set of communication topics on a distributed event store;
subscribing, by the intelligent log driver to the set of communication topics as a consumer, producer, or both;
selectively subscribing, by each application, to a respective first subset of the communication topics as a producer on the respective first subset of communication topics, and selectively subscribing, by each application, to a respective second subset of the communication topics as a consumer on the respective second subset of communication topics;
publishing messages containing events, logs, or commands, on individual communication topics of the respective first subsets of communication topics by the applications;
receiving the messages containing the events, logs, or commands, from the individual communication topics of the respective first subsets of communication topics by the intelligent log driver; and
implementing commands on the storage system, by the intelligent log driver, in response to messages received from the applications on first subsets of communication topics.

12. The common communication channel of claim 11, wherein the distributed event store is a Kafka server.

13. The common communication channel of claim 11, wherein the first subset of communication topics and the second subset of communication topics at least partially overlap.

14. The common communication channel of claim 13, wherein at least some of the applications are instantiated in different virtual machines on the storage system;
the method further comprising using the communication topics to enable communication between the instances of the applications instantiated in the different virtual machines.

15. The common communication channel of claim 11, wherein the set of communication topics created by the intelligent log driver on the distributed event store includes an events topic;
wherein selectively subscribing, by each application, to the respective first subset of the communication topics as producers comprises subscribing to the events topic as producers and publishing messages on the events topic related to occurrence of events at the respective applications; and
wherein selectively subscribing, by each application, to the respective second subset of the communication topics as consumers comprises subscribing to the events topic as consumers, reading the messages published to the events topic, and using the content of the messages published to the events topic to update respective user interface displays in accordance with the content of the messages read from the events topic.

16. The common communication channel of claim 15, wherein subscribing, by the intelligent log driver to the set of communication topics as a consumer comprises subscribing to the events topic both as a consumer and as a producer;
the method further comprising:
determining from the messages published to the events topic that one of two instances of a given application needs to be elected as master application; and
in response to determining that one of the two instances of the given application needs to be elected as the master application, publishing an election decision on the events topic to notify the two instances of the application which of the two instances has been elected the master application.

17. The common communication channel of claim 11, wherein the set of communication topics created by the intelligent log driver on the distributed event store includes a logs topic;
wherein selectively subscribing, by each application, to the respective first subset of the communication topics as producer comprises subscribing to the logs topic as producers and publishing messages containing logs related to application execution errors to the logs topic; and
wherein subscribing, by the intelligent log driver to the set of communication topics as a consumer comprises subscribing to the logs topic as a consumer;
the method further comprising:
reading the published messages containing the logs related to application execution errors by the intelligent log driver; and
in response to reading the published messages, interacting by the intelligent log driver with a storage system operating system to adjust physical resources made available to the applications by the storage system.

18. The common communication channel of claim 11, wherein the set of communication topics created by the intelligent log driver on the distributed event store includes a command topic; and
wherein selectively subscribing, by each application, to a respective first subset of the communication topics as producers comprises subscribing to the command topic as producers and publishing commands to be executed by the intelligent log driver on the command topic.

19. The common communication channel of claim 11, wherein the set of communication topics created by the intelligent log driver on the distributed event store includes a command topic;
wherein selectively subscribing, by each application, to the respective first subset of the communication topics as producers comprises subscribing to the command topic as producers and publishing commands to be executed by other applications on the command topic; and
wherein selectively subscribing, by each application, to the respective second subset of the communication topics as consumers comprises subscribing to the command topic as consumers and receiving commands to be executed from the other applications on the command topic.

20. The common communication channel of claim 1, wherein the intelligent log driver and the distributed events store are implemented as part of an application programming interface to an operating system of the storage system.
